(19) United States
(12) Patent Application Publication
(10) Pub. No.: US 2024/0240622 A1
(43) Pub. Date: Jul. 18, 2024

(54) Thermal Management System for Spacecraft Thruster

(71) Applicant: NEUTRONSTAR SYSTEMS UG, Köln (DE)

(72) Inventors: Morgan Chambard, Köln (DE); Manuel La Rosa Betancourt, Köln (DE); Marcus Collier-Wright, Köln (DE)

(21) Appl. No.: 18/562,023

(22) PCT Filed: May 20, 2022
(86) PCT No.: PCT/EP2022/063793

§ 371 Date: Nov. 17, 2023

(30) Foreign Application Priority Data
May 20, 2021 (DE) 10 2021 113 185.5
May 20, 2021 (GB) 2107263.2

(51) Int. Cl. F03H 1/00; B64G 1/40; H01F 6/04; H05H 1/24; H05H 1/54

(52) U.S. Cl. CPC F03H 1/0031; B64G 1/413; H01F 6/04; H05H 1/54; H05H 1/2431

(57) ABSTRACT

A thermal management system (5) for a magnetoplasmadynamic thruster (10) for a space craft is disclosed. The thermal management system (5) is located between at least one superconducting magnet (120) and a plasma discharge unit (15 and comprises a thermal barrier (40, 60) located adjacent to the plasma discharge unit (15), —a multilayer insulation (70) located between the thermal barrier (40, 60) and the cryostat insulation (80), and a radiation gap (50) located in the thermal barrier (40, 60).

### CROSS-REFERENCE TO RELATED APPLICATIONS

This application claims priority of the German Patent Application number DE 10 2021 113 185.5, filed on 20 May 2021 and the British Patent Application GB 2107263.2. The entire disclosure of the German Patent Application number DE 10 2021 113 185.5 and the British Patent Application GB 2107263.2 is hereby incorporated herein by reference

### FIELD OF THE INVENTION

The field of the invention relates to a thermal management system for a magnetoplasmadynamic thruster.

### BACKGROUND OF THE INVENTION

A magnetoplasmadynamic (MPD) thruster (MPDT) is a form of electrically powered spacecraft propulsion which uses the Lorentz force to generate thrust. The Lorentz force is the force exerted on a charged particle by an electromagnetic field. The magnetoplasmadynamic is sometimes referred to as a Lorentz Force Accelerator (LFA), a central-cathode electrostatic thruster or an MPD “arcjet”.

The MPDT works by feeding gaseous material into an acceleration chamber, where the gaseous material is ionized to form a plasma. The magnetic and electrical fields in the acceleration chamber are created using a power source. The ionized particles in the plasma are then propelled by the Lorentz force resulting from the interaction between the current flowing through the plasma and the magnetic field out through the exhaust chamber. Unlike chemical propulsion, there is no combustion of fuel. As with other electric propulsion variations, both specific impulse and thrust increase with power input, while thrust per watt drops.

There are two main types of MPD thrusters, applied-field and self-field. The applied-field MPD thrusters have external magnetic coils surrounding the exhaust chamber to produce an additional magnetic field.

Various gaseous materials are used for the plasma, such as but not limited to, xenon, neon, argon, hydrogen, hydrazine, ammonia, nitrogen, magnesium, methane, hydrogen/oxygen mixtures, and lithium. Lithium is generally being the best performer. Mixtures of the gaseous materials can also be used.

Electromagnetic propulsion systems for spacecraft are known in the art. For example, Japanese Patent No JP 5417643 B2 teaches a superconducting magnet device which can cool a superconducting magnet for use in a propulsion device.

International patent application Nr. WO 2020/174378 (Zenno Astronautics) also teaches the use of a spacecraft with a superconducting magnet and a cooling element. A cryocooler is connected to the cooling element. The superconducting magnet is used in a propulsion system which enables the interaction of the spacecraft's own magnetic field with external magnetic fields, such as the sun's magnetic field or the earth's magnetic field for steering and propelling the spacecraft. The application does not teach the use of a superconducting magnet in a magnetoplasmadynamic thruster.

The superconducting magnets are operated at low temperatures, e.g., around 50K. The temperature of the plasma in the plasma discharge unit of the thruster is much higher and thus there is a need to provide a thermal management system between the superconducting magnets and the plasma discharge unit to ensure that the temperature of the superconducting magnets does not exceed the critical temperature of the superconducting materials used in the superconducting magnets.

### BRIEF SUMMARY OF THE INVENTION

A thermal management system for a magnetoplasmadynamic thruster in, for example, a spacecraft is taught in this document. The thermal management system is located between at least one superconducting magnet and a plasma discharge unit to reduce substantially the thermal energy from the plasma discharge unit reaching the superconducting magnet and thereby destroying the superconductivity in the superconducting magnet.

The use of the thermal management system and the superconducting magnet enable greater efficiencies for the magnetoplasmadynamic thruster. In particular, the superconducting magnet enables strong magnetic fields to be generated and energy losses in the electrical circuits to be reduced. The thermal management system separates thermally the low temperature superconducting magnet at between 30-77K (generally around 50K) from the high temperature plasma discharge unit. The thermal management system enables the anode to operated at high temperatures of around 2000K which generates the plasma efficiently.

Unlike in the art, the anode does not have to be cooled by water cooling to manage the heat of the magnetoplasmadynamic thruster as the combination of the thermal management system and radiative cooling in space enables management of the temperature.

The thermal management system comprises in one aspect a thermal barrier located adjacent to the plasma discharge unit, a cryostat insulation layer located adjacent to the at least one superconducting magnet, and a multilayer insulation located between the thermal barrier and the cryostat insulation. A radiation gap is located in the thermal barrier.

The thermal management system comprises a primary thermal barrier located adjacent to the plasma discharge unit and a secondary thermal barrier located adjacent to the multilayer insulation. The radiation gap is located between the primary thermal barrier and the secondary thermal barrier and the primary thermal barrier and the secondary thermal barrier are separated by a plurality of thermal expansion spacer units.

The plasma discharge unit comprises an anode concentrically located to a central cathode.

In one aspect, the primary thermal barrier is made of a ceramic and the secondary thermal barrier is made of one of a ceramic, an alloy, or a superalloy. The multi-layer insulation layer comprises several layers of foils.

### DESCRIPTION OF THE FIGURES

FIG. 1 shows an overview of a magnetoplasmadynamic thruster.

FIG. 2 shows a cross-section of the magnetoplasmadynamic thruster.

FIG. 3 shows a cross section of the thermal management system.

FIG. 4 shows a simulation of a thermal diagram across the thermal management system.

FIG. 5 shows a connection technique for maintaining thermal separation in a vacuum gap in the thermal management system.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

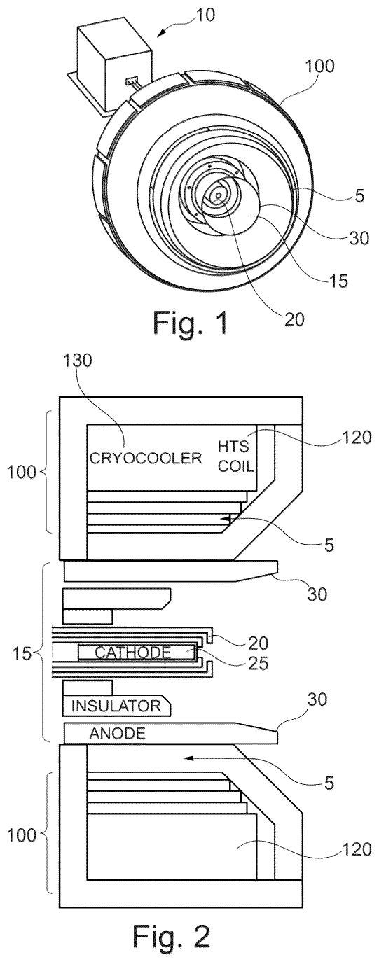

FIG. 1 shows an overview of a magnetoplasmadynamic thruster 10 with a thermal management system 5 and FIG. 2 shows a cross-sectional view of the magnetoplasmadynamic thruster 10. The magnetoplasmadynamic thruster 10 is used, for example, on a spacecraft and comprises a plasma discharge unit 15 with two concentric electrodes, a cathode 20 and an anode 30. The cathode 20 and the anode 30 are both of a substantially cylindrical geometry.

The design of the cathode 20 is of the hollow cathode variety and includes a thermionic insert 25 made, for example, of lanthanum hexaboride. Other materials can be used which are thermionic emitters and characterised by having a low work function e.g., Barium Oxide Scandate, Barium Oxide Tungsten, Molybdenum, Tantalum, Tungsten, Lanthanum Molybdenum, Calcium Aluminate, Cerium Hexaboride, Cermet, etc. Similar materials with relevant impregnates including but not limited to Barium Oxide, Calcium Oxide, Aluminium Oxide can be used.

The anode 30 is a hot anode at temperatures between, for example, 1600K and 2500K. The anode 30 and is made from an electrically conductive material with high temperature resistance and a low work function, for example Tungsten, Molybdenum, Tantalum, Niobium, Chromium, Hafnium, Iridium, Osmium, rhodium, Ruthenium, Titanium, Vanadium, Zirconium, and alloys thereof. The anode may be coated with a carbon-based surface layer, such as carbon nanotubes (CNT) or graphene, to improve performance.

The two concentric electrodes (cathode 20 and anode 30) and the volume between the cathode 20 and the anode 30 comprise collectively the plasma discharge unit 15. The cathode 20 and the anode 30 have a common central axis. The use of the lanthanum hexaboride thermionic insert 25 in the hollow cathode 20 extends the lifetime of the magnetoplasmadynamic thruster 10 by reducing the erosion rates associated with other types of cathode.

A superconducting magnet system 100 is located outside of the plasma discharge unit 15. The superconducting magnet system 100 comprise a plurality of superconducting magnets 120 (for example in the form of a superconducting coil) within a cryostat 130 together with the necessary cables for delivering electrical power to the superconducting magnets 120. The superconducting magnet system 100 has a first set of superconducting magnets 120 which are used for providing a magnetic field which contributes to the acceleration of the plasma in the direction of the central axis through the interaction with the current between the cathode 20 and the anode 30, by means of a Lorentz Force, a Hall acceleration, a swirl acceleration, and a thermodynamic acceleration arising from the expansion of the hot gas and plasma within the plasma discharge unit 15. The swirl acceleration arises from the swirling motion of the plasma 70 due to the presence of the applied magnetic field B.

The superconducting magnets 120 are produced of a rectangular cross section with a superconducting layer being formed of any type of superconductor. Examples of the superconductors include, but are not limited to, type 2G high-temperature superconductors (HTS) such as Yttrium Barium Copper Oxide, Lanthanum Barium Copper Oxide and other Rare-Earth Barium Copper Oxides, Magnesium Diboride, Bismuth Strontium Calcium Copper Oxide (Bi2223 or Bi2212). The use of very high-temperature superconductors, including those which require higher pressures for operation, and those which could be operated at room temperature, are also considered as potential materials.

The number and positioning of the individual superconducting magnets 120 within the superconducting magnetic system 100 can be varied and are not limiting of the invention.

A second set of superconducting magnets 120 are used to produce a magnetic field nominally in the axial direction of the magnetoplasmadynamic thruster 10, but whose direction can be altered with a deflection of up to plus/minus 10 degrees in any direction about the thruster central axis, preferably up to plus/minus 20 degrees, preferably up to plus/minus 40 degrees, and most preferably up to plus/minus 60 degrees.

The Applicant's co-pending patent application No. GB 2017811.7 filed on 11 Nov. 2020 provides more details of the superconducting magnet system 100 and the superconducting magnets 120 and the teachings of this patent application are incorporated herein by reference.

The superconducting magnets 120 as well as the other elements of the superconducting magnet system 100 are kept cool by a corresponding cryogenic system. Such a system uses cooling technologies such as, but not restricted to, Pulse Tube Tactical Cooling: Pulse Tube Miniature Tactical Cooling: Joule-Thompson Coolers: Reverse Turbo-Brayton Coolers: and Stirling Cryocoolers. The coolers are connected with the superconducting magnets 120 and are located within the cryostat 130 which maintains the operational temperature for the operation of the superconducting magnets 120. In an alternative aspect of the thruster system, the use of a radiatively cooled superconductors in the superconducting magnets is envisaged as a possibility which do not require the cryogenic system. The use of the superconducting magnets 120 enables strong magnetic fields to be generated with very little electrical loss.

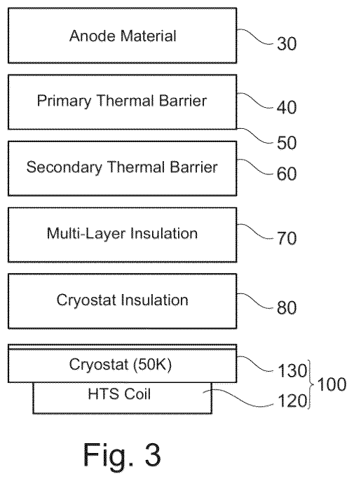

The thermal management system 5 is located between the plasma discharge unit 15 and the superconducting magnet system 100. The thermal management system 5 enables the superconductors can operate below their critical temperature (50K or less) in the presence of high temperatures at the plasma plume (1600K or more). The thermal management system 5 is shown in more detail in FIG. 3 and is comprised of several layers of insulation which form a multi-layer, multi-material architecture.

A primary thermal barrier 40 is located adjacent to the anode 30. The primary thermal barrier is made of ceramics, such as but not limited to Hafnium, Alumina, Mullite, Silicon Carbide, Cesic™ (Silicon Carbide), and Shapal™ (combination of Aluminium Nitride and Boron Nitride). The materials of the primary thermal barrier are chosen to have a high temperature resistance (Continuous Use Temperature >2500K) (as the primary thermal barrier 40 is located adjacent to the anode 30 and is at a temperature of 2000K). The materials will also have a high specific heat capacity (>500 J/K·kg) to absorb the energy from the plasma in the plasma discharge unit 15.

A secondary thermal barrier 60 is located about the primary thermal barrier 40 and is separated from the primary thermal barrier 40 by a radiation gap 50. FIG. 5 shows a cross-section of the radiation gap 50 and will be described later. The secondary thermal barrier 60) is also made of ceramics, alloys, or superalloys, such as but not limited to Silicon Nitride, Aluminium Nitride, Zirconia, Inconel, and Nickel-Chrome. The materials of the secondary thermal barrier 60 have a low thermal conductivity (>25 W/mK) as well as a high specific heat capacity (>500 J/K·kg).

A multi-layer insulation layer 70 surrounds the secondary thermal barrier 60. The multilayer insulation 70 is made of several layers of materials with a low thermal conductivity (>1 W/mk) and low density (>1.5 g/cm³) as well as having a high degree of reflectivity for thermal radiation. Examples of such materials include, but are not limited to, Mylar foils, aluminised polyester foils, aluminium foils, and Kapton, coated with thin layers of material such as silver or aluminium, and structured with spacers formed of, for example, polyester or glass.

A cryostat insulation 80 surrounds the multilayer insulation 70. The cryostat insulation 80 has also a low thermal conductivity and a low density. The cryostat insulation 60 is made, for example of aerogels such as Cryogel® Z or Polyimide foam, aerogel reinforced composites such as Aluminosilicates, or fabrics such as, Nextel.

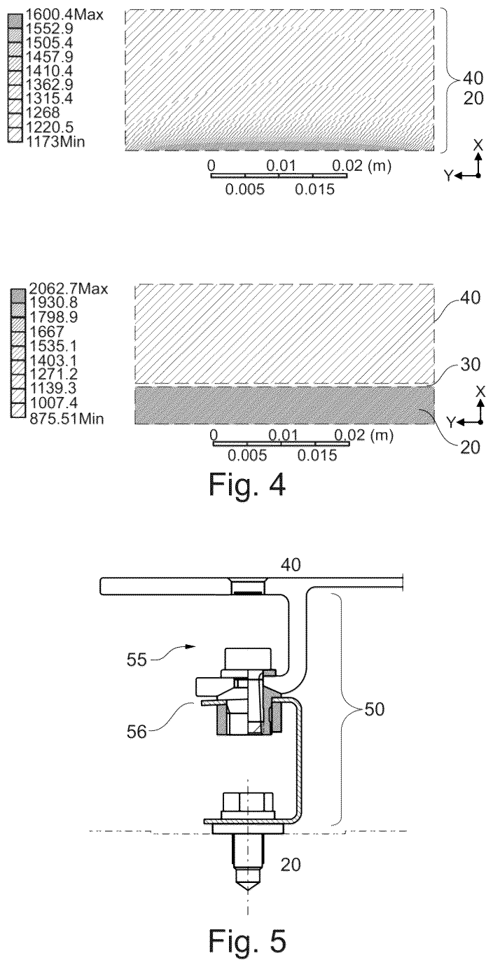

An example of the temperature gradient across part of the thermal management system is shown in FIG. 4 in which the effect of the primary thermal barrier 40, the radiation gap 50 and the secondary thermal barrier 60 is to reduce the temperature from around 2000K at the plasma discharge unit 15 to approximately 875K.

FIG. 5 shows a cross-sectional view of the radiation gap 50 between the primary thermal barrier 40 and the secondary thermal barrier 60 with a connecting element to keep the primary thermal barrier 40 structurally separated from the secondary thermal barrier. A non-limiting example of a thermal expansion spacer unit 55 is used to separate the primary thermal barrier 40 and the secondary thermal barrier 60 with an expansion compensation element 56 located in the thermal expansion spacer unit 55.

The thermal management system 5 may also contain embedded sensors which monitor the temperature and pressure within the system, in order to monitor the physical stability and condition of the system by monitoring the temperature gradient. Such sensors are connected with the thruster control software by means of telemetry in order to adjust operational parameters to respond to changes in detected values. Should, for example, the sensors detect a higher temperature (or an unexpected increase in temperature) in the thermal management system, this could imply that heat is being lost from the interior of the propulsion unit and the efficiency of the propulsion unit being reduced.

Sensors which can withstand the high temperatures are known. For example, sensors made of a silicon carbide allow which withstand temperatures up to 1600K can be used in the thermal management system 5.

### REFERENCE NUMERALS

5 Thermal management system
10 Magnetoplasmadynamic thruster
15 Plasma discharge unit
20 Cathode
25 Thermionic insert
30 Anode
40 Primary thermal barrier
50 Radiation gap
55 Thermal expansion spacer units
60 Secondary thermal barrier
70 Multilayer insulation layer
80 Cryostat insulation layer
100 Superconducting magnet system
120 Superconducting magnets
130 Cryostat

1. A thermal management system for a magnetoplasmadynamic thruster, the thermal management system being located between at least one superconducting magnet and a plasma discharge unit, the thermal management system comprising:
a thermal barrier located adjacent to the plasma discharge unit;
a cryostat insulation layer located adjacent to the at least one superconducting magnet; and
a multilayer insulation located between the thermal barrier and the cryostat insulation; and
a radiation gap located in the thermal barrier.

2. The thermal management system of claim 1, wherein the thermal barrier comprises a primary thermal barrier located adjacent to the plasma discharge unit and a secondary thermal barrier located adjacent to the multilayer insulation, and wherein the radiation gap is located between the primary thermal barrier and the secondary thermal barrier.

3. The thermal management system of claim 2, wherein the primary thermal barrier and the secondary thermal barrier are separated by a plurality of thermal expansion spacer units.

4. The thermal management system according to claim 1, wherein the plasma discharge unit comprises an anode concentrically located to a central cathode.

5. The thermal management system according to claim 1, wherein the primary thermal barrier is made of a ceramic.

6. The thermal management system according to claim 1, wherein the secondary thermal barrier is made of one of a ceramic, an alloy, or a superalloy.

7. The thermal management system according to claim 1, wherein the multi-layer insulation layer comprises several layers of foils.
